(19) United States
(12) Patent Application Publication
(10) Pub. No.: US 2020/0193536 A1
(43) Pub. Date: Jun. 18, 2020

(54) SYSTEM AND METHOD OF EVALUATING A SUBJECT PROPERTY WITH OTHER REAL ESTATE PROPERTIES LISTED FOR SALE

(71) Applicant: Neil Jeffrey Binder, New York, NY (US)

(72) Inventor: Neil Jeffrey Binder, New York, NY (US)

(21) Appl. No.: 16/217,650

(22) Filed: Dec. 12, 2018

(51) Int. Cl. G06Q 50/16; G06F 16/9535; G06Q 30/02

(52) U.S. Cl. CPC G06Q 50/16; G06Q 30/0278; G06F 16/9535

(57) ABSTRACT

A system and method to evaluate a subject property. The system and method include filtering comparison properties in a search pool of properties listed for sale using filtering criteria including at least one search feature. The search features are attributes associated with the subject property. The search features have an attribute value associated with each of the comparison properties. An average attribute value associated with the search features for the comparison property is calculated. A difference between the average attribute value of the comparison properties and an attribute value of the attribute associated with the subject property is calculated to evaluate the subject properties value with other comparison properties on the market.

### BACKGROUND OF THE INVENTION

The present invention relates to a method of determining property value.

Property valuation is normally performed by evaluating historical transactions to define current value. Accordingly, sellers of properties are often unaware of the current competitive forces that should be considered in pricing their property. Sellers are often confused about how to price their property because real estate brokers offer them only Comparative Market Analysis that presents apartments that have sold rather than apartments that are selling. In turn a buyer is uncertain about what to bid on an apartment unless they see a large number of apartments to gain an impression of what alternatives exist in the market. Even in this case, they continue to have high uncertainty.

As can be seen, there is a need for an improved method of determining property value

### SUMMARY OF THE INVENTION

In one aspect of the present invention, a method of evaluating a subject property with real estate properties listed for sale, the method comprises: filtering, using a computing system, comparison properties in a search pool of properties listed for sale using filtering criteria including at least one search feature comprising an attribute associated with the subject property, the at least one search feature having an attribute value associated with each of the comparison properties; determining, using the computing system, an average attribute value associated with the at least one search feature for the comparison property; and determining, using the computing system, a difference between the average attribute value of the comparison properties and an attribute value of the attribute associated with the subject property.

In another aspect of the present invention, a system to evaluate a subject property with real estate properties listed for sale, the system comprises: a database storing a search pool that includes information from a plurality of properties listed for sale; a device including a processor and a memory for storing instructions that, when executed by the processor, cause the processor to perform operations comprising: filtering comparison properties in a search pool of properties listed for sale using filtering criteria including at least one search feature comprising an attribute associated with the subject property, the at least one search feature having an attribute value associated with each of the comparison properties; determining an average attribute value associated with the at least one search feature for the comparison property; and determining a difference between the average attribute value of the comparison properties and an attribute value of the attribute associated with the subject property.

These and other features, aspects and advantages of the present invention will become better understood with reference to the following drawings, description and claims.

### BRIEF DESCRIPTION OF THE DRAWINGS

FIG. 1 illustrates a block diagram of a networked computer system for evaluating a subject property according to an embodiment of the present invention;

FIG. 2 is a flow chart of a method executed by the system of FIG. 1 for evaluating a subject property according to an embodiment of the present invention;

FIG. 3 illustrates an example of determining an attribute value of an embodiment of the present invention;

FIG. 4 is a flow chart of a method executed by the system of FIG. 1 for evaluating a subject property according to an embodiment of the present invention;

FIG. 5 is a continuation of the flow chart of FIG. 4;

FIG. 6 is a continuation of the flow chart of FIG. 5;

FIG. 7 is an exemplary chart of data presented by an embodiment of the present invention;

FIG. 8 is an exemplary chart of data presented by an embodiment of the present invention; and

FIG. 9 is an exemplary chart of data presented by an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a method of determining property value by comparing a subject property to a similar population of comparison properties in order to identify its value. The methodology compares a property for sale (the subject property) against a population of similar properties for sale using defined criteria that are measured and then valued. This creates means to evaluate the seller's competition in the marketplace in order to correctly price the property. The present invention gives the seller a clear impression of how his property compares to other choices available to a buyer that are comparable to their own property. The present invention assists a seller to properly determine a price that is reasonable in light of current competitive forces and to recognize the advantages and disadvantages of the subject property relative to other competing properties. The present invention allows a buyer to evaluate their alternatives and enable them to bid appropriately for desired real estate with confidence that their offer is reflective of its current worth.

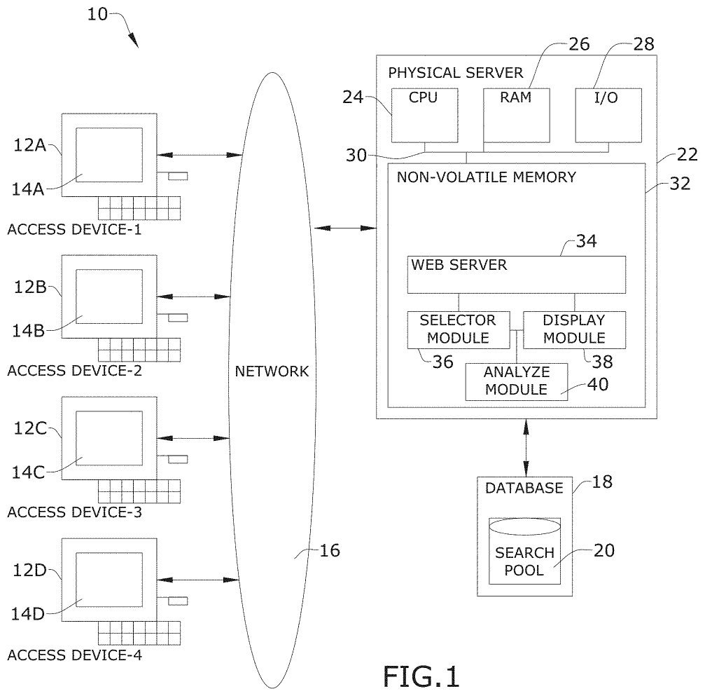

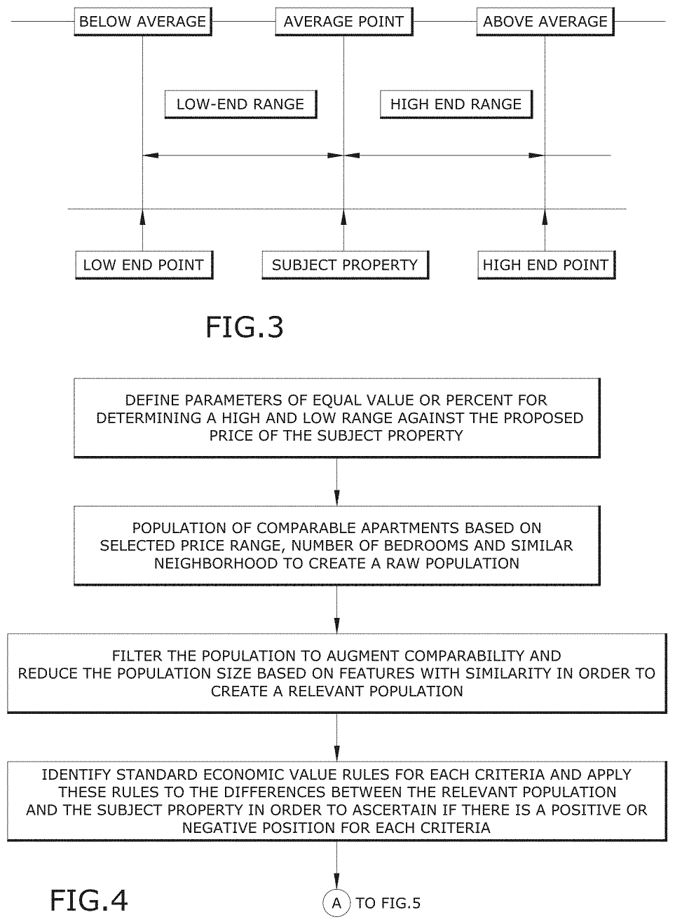

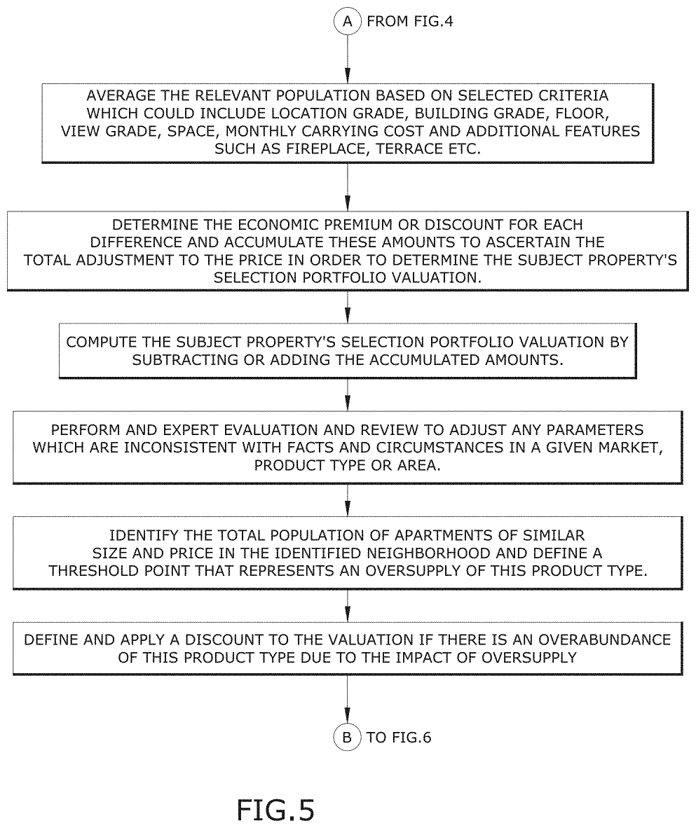

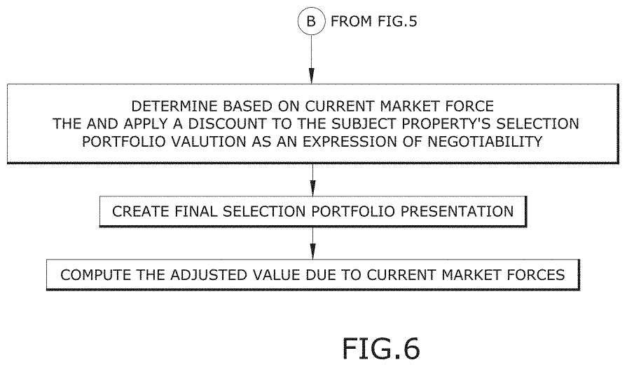

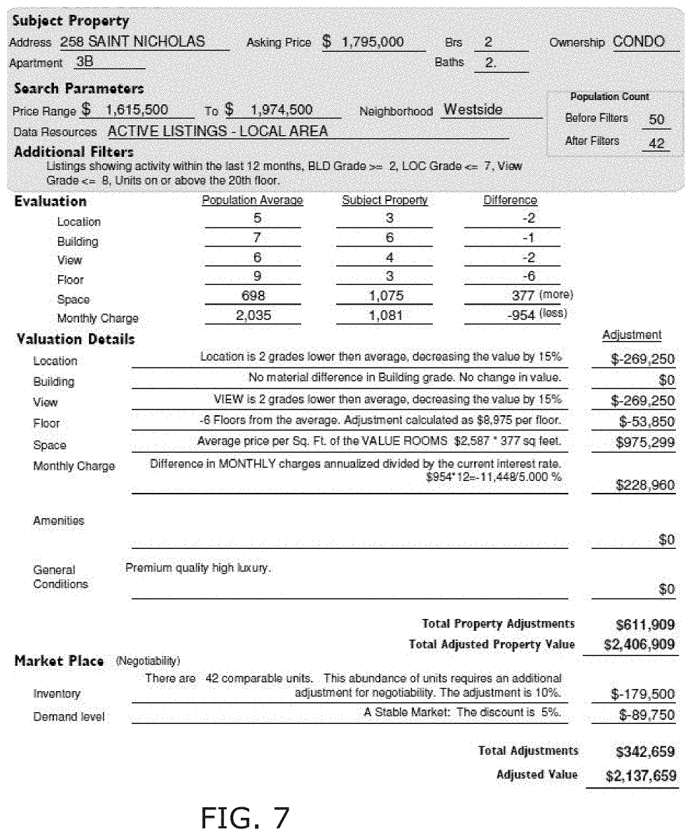

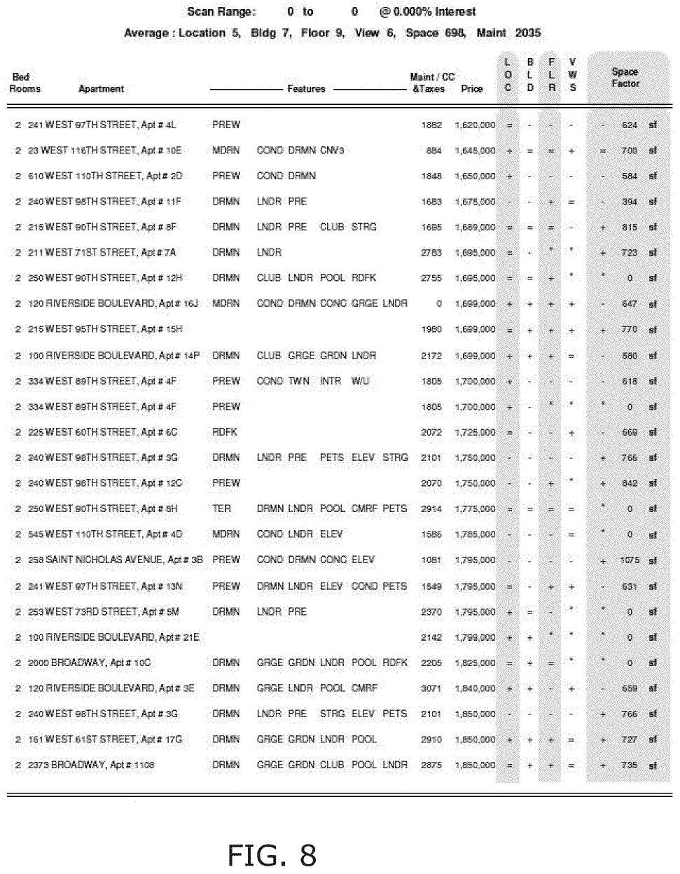

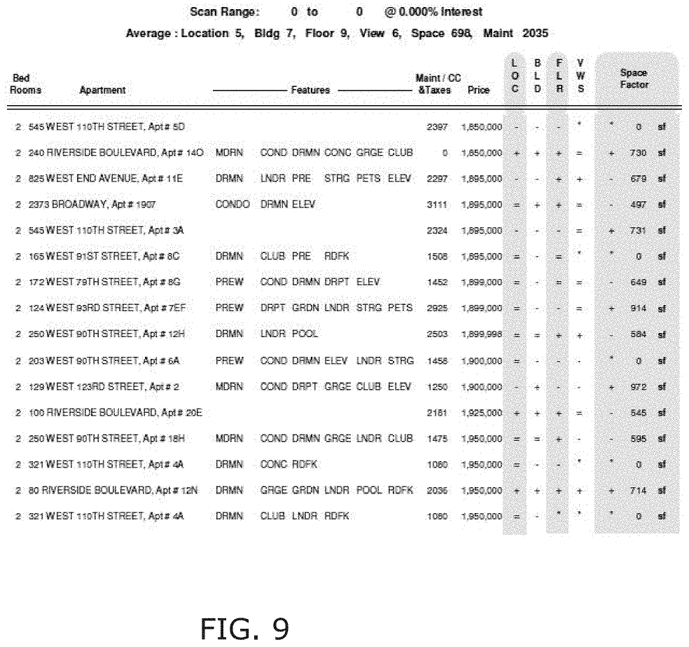

Referring to FIGS. 1 through 9, in one preferred embodiment, a computer-based system 10 that analyzes real estate properties is disclosed. The system 10 includes a server 22 that evaluates real estate property information in response to requests from access devices 12A-D. As shown in FIG. 1, a user using an access device 12A-D over a network 16 can access the server 22 to request and receive the real estate property information.

In the embodiment shown in FIG. 1, each access device 12A-D is configured with a web browser 14A-D capable of requesting and displaying the real estate property information. The access devices 12A-D can include a personal computer, a laptop computer, or other electronic-based device to access the server 22. Although only four access devices are illustrated in FIG. 1, the system 10 can be configured to support various numbers of access devices.

Network 16 can include various devices such as servers, routers, and switching elements that can be connected in an extranet, intranet or Internet configuration. In some implementations, the network 16 uses wired communications to transfer information to and from the access devices 12A-D and the server 22. In other implementations, the network 16 uses wireless communication protocols. In yet other implementations, the network 16 uses a combination of wired and wireless communication protocols

Database 18 provides access to descriptive information relating to one or more real estate properties and is accessible to the server 22. In one preferred embodiment, the database 18 is a relational database that maintains real estate property information in a search pool 20. In another preferred embodiment, the database 18 is a directory server, such as a Lightweight Directory Access Protocol (‘LDAP’) server, that maintains real estate information in the search pool 20. In other implementations, the database 18 and search pool 20 are a configured area in the non-volatile memory 32 of the server 22 that maintains real estate property information. Of course, it will be appreciated by one skilled in the art that the database 18 can also be accessed over the network 16 and can be used to not only maintain real estate descriptive information but can also be used to store calculated real estate information as described below.

As shown in FIG. 1, the server 22 includes a central processing unit (‘CPU’) 24, random access memory (‘RAM’) 26, non-volatile memory 32 and an input-output device 28, all of which are interconnected via a bus line 30 and controlled by the CPU 24. The non-volatile memory 32 is configured to include a web server 34 to communicate with access devices 12A-D, a selector module 36 to determine search features associated with property in the search pool 20, an analyze module 40 to identify comparison properties from the search pool 20 and a display module 38 to display pictorially attributes of the comparison properties.

Web server 34 manages communications between the access devices 12A-D and the server 22. Preferably, the web server 34 is configured to send and receive information in the form of web pages to any of the browsers 14A-D in response to a request. The web server 34 communicates with each web browser 14A-D and software modules 36, 38 and 40 using one or more communication protocols, such as HTTP (Hyper Text Markup Language). In one preferred embodiment, for example, the web server 34 is configured to include the Apache HTTP Server from the Apache Software Foundation. In another preferred embodiment, the web server 34 includes Internet Information Services (IIS) from Microsoft Corporation. In yet another preferred embodiment, the web server 34 includes the Sun Java System Web Server from Sun Microsystems.

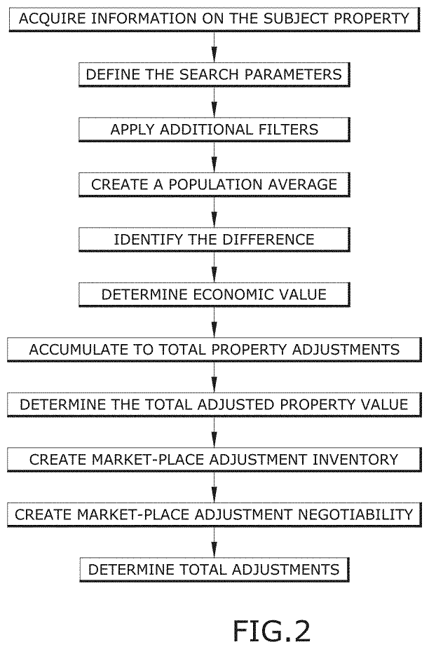

Referring now to FIGS. 2 through 4, flow charts and schematic views of a method executed by the system of FIG. 1 to evaluate a subject properties value are disclosed. The method includes filtering comparison properties in a search pool of properties listed for sale using filtering criteria including at least one search feature. The search features are attributes associated with the subject property. The search features have an attribute value associated with each of the comparison properties. An average attribute value associated with the search features for the comparison property is calculated. A difference between the average attribute value of the comparison properties and an attribute value of the attribute associated with the subject property is calculated to evaluate the subject properties value with other comparison properties on the market.

To determine appropriate search features, information is gathered of the subject property and defined. The search features may include primary motivating criteria (Primary Motivators) in making a buying decision and secondary amenities that may offer additional value. The primary motivators may include factors that are fundamental to the buying decision such as price and monthly cost. For example, in cooperative and condominium ownership, the primary motivators include the financial factors of price and monthly cost as well as the aesthetic factors of location, building, view, floor and space. Each of these have a means of comparing one property to another in formulating some assessment about the relative advantages or disadvantages of each alternative. Secondary elements may be used for market price adjustment. For the purpose of valuation, the market price adjustment may be immaterial because it is presumed to affect all apartments in a similar population somewhat evenly. However, for a buyer looking to make a decision at a given period of time on purchasing a property it may be a material factor in deciding the amount they wish to bid.

The search features each have an attribute value associated with each of the comparison properties. For example, in apartment ownership, the building is a primary motivating criteria. A low attribute value of “1” might be given for a walk-up building in disrepair and a high attribute value of “10” might be given for an international prestige full service building. A middle attribute value of “5” might be defined as a doorman building with no special amenities. Thereafter, the definer can develop relative levels of variation to for attribute values of 2, 3, and 4 lying below the median as well as 6, 7, 8, and 9 lying above the median. Once a full 1 to 10 scale has been formulated, each building in a designated area, such as a city or county, can be assigned an attribute value based on an evaluation referencing this grading system. Space is also a criterion however in this circumstance the relational value is measurement: an apartment with 500 square feet of living space would be considered less valuable when compared to another apartment that has 600 square feet. For example, the difference in footage is multiplied by the average price per foot. This same procedure is applied for all the primary motivators. Subsequently secondary amenities are evaluated to make additional adjustments. These might include the condition of the apartment, whether it has a terrace or an eat in kitchen or other factors of similar importance.

A difference between the average attribute value of the comparison properties and an attribute value of the attributes associated with the subject property is calculated to evaluate the subject properties value with other comparison properties on the market. Determining the average attribute value includes summing the attribute value for each comparison property into a sum, and dividing the sum by a total number of the comparison properties.

Once the difference between the average attribute value of the comparison properties and the attribute value of the subject property is determined, an economic value of the difference is calculated. Economic values may be created by means of percentage, absolute amounts or algorithms are used in developing a conclusion on the economic effect of any difference in the criteria identified. The property value of the subject property is then determined. The valuation of the subject property is determined by adding the economic value of any difference together and then subtracting the economic value of any current market place conditions from the value of the subject property. The computing system may then depict the adjusted valuation of the subject property.

The present invention may further include the steps of performing an expert evaluation and review to adjust any parameters which are inconsistent with facts and circumstances in a give market, product type or area. The steps may further include identifying the total population of apartments of similar size and price in the identified neighborhood and defining a threshold point that represents an oversupply of this product type. The steps may further include defining and applying a discount to the valuation if there is an overabundance of this product type due to the impact of oversupply. Further, the steps may include determining based on the current market force and appling a discount to the subject property's selection portfolio valuation and as an expression of negotiability. The Steps may further include creating a final selection portfolio presentation and computing the adjusted value due to the current market forces.

Valuation requires competitive choices that can be purchased (identifying similar apartments which can be utilized for the comparison). Searching the pool of properties utilizing search criteria identifies properties for sale (from a real estate brokers listing book or from an MLS service) that are competitors to the subject property. These properties are alternatives a buyer might choose when evaluating the best choice- the property which the most positive qualities that are deemed important to them at the lowest price. Thus, by creating a population average attribute value in order to identify the central tendency of value for a selected type of property and then comparing the attribute value of the subject property when compared to those of these competing alternatives, a conclusion can be made about what is the appropriate value of the subject property when compared to other choices.

The positive and negative effects of variations are economically defined: Having variation only has significance if it can be put into the context of a meaning that as a buyer or seller can understand. This is done by creating economic value to each conclusion. To the extent that any economic value is not acceptable to a seller (or buyer) the economic value can be adjusted upward or downward to reflect that party's level of knowledge and awareness, however, this does not mean that the economic implications are meaningless only that there is a difference of opinion by how much. This valuation report seeks to be a transparent means to provide the foundation for formulating such conclusions which can be accepted or rejected based on facts and circumstance. In any case, the economic effect can be resolved. The accumulation and adjustments permit time sensitive factors to be considered in the valuation and the comparison of properties included in the average permits transparency and validation to improve the evaluator's inclination to rely on the valuation report's conclusions. The important issue for the valuation procedure is the validity of the economic values assigned to differences. A continuing effort is made to survey the market in order to ensure that amounts proposed are credible and supportable.

The methodology of the present invention can be utilized for any valuation of any kind of property by merely adjusting the assigned primary motivators to conform to the essential features of that kind of property in the marketplace as well as adjusting the economic values associated with any differences between a subject property and an similar average population. For example, a company is seeking to be valued. The party making the valuation creates a listing of fundamental criteria that would be applicable to any corporation in a similar business. This might include value of branding, penetration in the market, productivity factors, management factors, rates of return, value of assets owned by the company and other factors. Thereafter, the evaluator can identify secondary factors which they think may add value above and beyond primary factors such as perceived subsequent durability of the service or product, the ability to create ancillary services etc. By grading and measuring the entire population of similar companies a determination can be made of the relative differences to an average and the appropriate value of the company compared to this average. The present invention can be used for an array of assets that can apply the methodology for the purpose of educating a buyer and seller as well as assisting in the valuation.

It should be understood, of course, that the foregoing relates to exemplary embodiments of the invention and that modifications may be made without departing from the spirit and scope of the invention as set forth in the following claims.

What is claimed is:

1. A method of evaluating a subject property with real estate properties listed for sale, the method comprising:
filtering, using a computing system, comparison properties in a search pool of properties listed for sale using filtering criteria including at least one search feature comprising an attribute associated with the subject property, the at least one search feature having an attribute value associated with each of the comparison properties;
determining, using the computing system, an average attribute value associated with the at least one search feature for the comparison property; and
determining, using the computing system, a difference between the average attribute value of the comparison properties and an attribute value of the attribute associated with the subject property.

2. The method of claim 1, wherein the method further comprises:
defining, using the computing system, an economic value of the difference between the average attribute value of the comparison properties and an attribute value of the attribute associated with the subject property; and
adjusting, using the computing system, a valuation of the subject property based on the economic value of the difference.

3. The method of claim 2, wherein the method further comprises:
depicting, using the computing system, the adjusted valuation of the subject property.

4. The method of claim 2, wherein the at least one search feature is a plurality of search features each comprising a different attribute associated with the subject property, the plurality of search features each having an attribute value associated with each of the comparison properties.

5. The method of claim 1, wherein determining the average attribute value comprises:
summing the attribute value for each comparison property into a sum; and
dividing the sum by a total number of the comparison properties.

6. The method of claim 1, wherein the search feature is selected from the group consisting of property type, amount of bedrooms, amount of bathrooms, cost of living, location, building type, light, and space.

7. A system to evaluate a subject property with real estate properties listed for sale, the system comprising:
a database storing a search pool that includes information from a plurality of properties listed for sale;
a device including a processor and a memory for storing instructions that, when executed by the processor, cause the processor to perform operations comprising:
filtering comparison properties in a search pool of properties listed for sale using filtering criteria including at least one search feature comprising an attribute associated with the subject property, the at least one search feature having an attribute value associated with each of the comparison properties;
determining an average attribute value associated with the at least one search feature for the comparison property; and
determining a difference between the average attribute value of the comparison properties and an attribute value of the attribute associated with the subject property.

8. The system of claim 7, wherein the operations further comprise:
defining an economic value of the difference between the average attribute value of the comparison properties and an attribute value of the attribute associated with the subject property; and
adjusting a valuation of the subject property based on the economic value of the difference.

9. The system of claim 8, wherein the operations further comprise:
depicting, using the computing system, the adjusted valuation of the subject property.

10. The system of claim 7, wherein the at least one search feature is a plurality of search features each comprising a different attribute associated with the subject property, the plurality of search features each having an attribute value associated with each of the comparison properties.

11. The system of claim 7, wherein determining the average attribute value comprises:
summing the attribute value for each comparison property into a sum; and
dividing the sum by a total number of the comparison properties.

12. The system of claim 7, wherein the search feature is selected from the group consisting of property type, price range, amount of bedrooms, amount of bathrooms, cost of living, location, building type, light, and space.
